(19) United States
(12) Patent Application Publication
(10) Pub. No.: US 2009/0154600 A1
(43) Pub. Date: Jun. 18, 2009

(54) QRD-QLD searching based sphere detector for MIMO receiver

(75) Inventors: Kyeong Jin Kim, Irving, TX (US); Predrag Radosavljevic, Houston, TX (US); Joseph R. Cavallaro, Pearland, TX (US)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/002,017

(22) Filed: Dec. 14, 2007

(51) Int. Cl. H04L 27/06

(52) U.S. Cl. 375/320; 375/316

(57) ABSTRACT

An apparatus includes a receiver configurable to receive signals from y pairs of antennas, where y is greater than one, and where the received signals convey coded bits of information. The apparatus further includes a detection block that includes a plurality of search modules configurable to process signals received from pairs of the antennas in parallel to find partial Euclidian distances and determine valid partial candidates for individual antennas; and a plurality of sort modules configurable to sort the valid partial candidates to find M best partial candidates to be combined into M² final candidates. The apparatus further includes a plurality of a posteriori probability function units arranged to process the M² final candidates in parallel, with corresponding final Euclidian distances, to determine a posteriori reliability information for coded bits. As an example, the signals are received from four antennas and are modulated using 16-QAM modulation. The apparatus may be embodied at least partially as an integrated circuit that provides a QRD-QLD detection algorithm as part of a wireless MIMO OFDM downlink receiver.

### TECHNICAL FIELD

The exemplary and non-limiting embodiments of this invention relate generally to wireless communication systems, methods, devices and computer program products and, more specifically, relate to techniques for receiving a transmission in a multiple input-multiple output wireless communication system.

### BACKGROUND

Various abbreviations that appear in the specification and/or in the drawing figures are defined as follows:

3GPP 3rd generation partnership project

ASIC application specific integrated circuit

MAP maximum a posteriori

MIMO multiple input multiple output

LTE long term evolution

OFDM orthogonal frequency division multiplexing

PED partial Euclidian distance

QAM quadrature amplitude modulation

QLD QL decomposition

QRD QR decomposition

SISO soft input soft output

Of particular interest herein are detection algorithms for MIMO OFDM downlink receivers, such as those utilized in emerging wireless standards targeting high data-rates. In such wireless systems a large spectral efficiency is assumed, and multiple transmit antennas are combined with high-order modulation. A particular problem that arises at the receiver is the very large computational complexity of various proposed detection algorithms that exhibit an excellent quality of service, such as MAP detection. The high computational complexity can inhibit, or prohibit, the use of such algorithms in a practical implementation. As a result, sub-optimal detection schemes that exhibit an acceptable error-rate performance, with a reduced computational complexity/latency, are becoming particularly attractive. One such lower complexity detector algorithm is known as the sphere detection algorithm.

In order to provide the lower complexity approximation of optimal joint detection-decoding, an inner soft sphere detector is interfaced with an outer SISO channel decoder. There are several proposed sphere detection schemes. One of the most popular is the QRD-M or K-best detection sphere algorithm, with M=16, that is proposed for emerging MIMO OFDM downlink receivers, such as 3GPP-LTE, IMT-advance, 4G, WLAN, and WiMAX downlink receivers. This algorithm provides a high and constant detection throughput with acceptable error-rate performance.

Reference may be made to K. J. Kim et al, “A QRD-M/Kalman filter-based detection and channel estimation algorithm for MIMO-OFDM systems”, IEEE Trans. on wireless communication, vol. 4, pp. 710-721, 2005 for a description of conventional QRD-M detection.

Reference may also be had to K. Jeon e al., “An Efficient QRD-M Algorithm Using Partial Decision Feedback Detection”, Signals, Systems and Computers, 2006, ACSSC '06, Fortieth Asilomar Conference, October-November 2006, pgs. 1658-1661.

As explained by Jeon et al., in the conventional QRD-M algorithms the channel matrix H is decomposed as H=QR by using the QR decomposition based on the modified Gram-Schmidt (MGS) method, where Q is an Nᵣ×Nₜ unitary matrix and R is an Nₜ×Nₜ upper triangular matrix. The matrix R is represented as shown in FIG. 1A. By pre-multiplying the equation r=Hs+n, where s denotes the vector of transmit symbols, r is the receive signal vector and n is the complex additive white Gaussian noise with variance Nₒ at Nᵣ receive antennas, by Q^{H}, one has:

y=Q^{H}r=Rs+n′,

where y is the Nᵣ×1 vector and the statistics of the Nᵣ×1 noise vector n′=Q^{H}n remains unchanged. The foregoing equation is converted into a tree structure by using the property of the matrix R.

The QRD-M algorithm starts from calculating the first branch metrics for all possible s₁. The branch metrics are calculated as:

|y₁−R_{1,1}s₁|².

At the first stage, constant M branches with the smallest accumulated metrics are selected as survival paths. At the second stage, each survival path is extended to |Ω| branches, where |Ω| is the cardinality of modulation set Ω. Therefore, there are M|Ω| combinations of s₁ and s₂. Only M paths with the smallest accumulated metrics out of M|Q| are selected. This process is repeated until Nₜ tree depth. At the last stage, a path with the minimum accumulated metric is detected.

The use of QRD-M detection significantly reduces the complexity of a ML algorithm, where the search for the most probable transmitted vector-candidate is performed jointly for all transmit antennas. The QRD-M algorithm assumes a breadth-first candidate-search where all symbol-candidates for one transmit antenna are first found before continuing the candidate-search for the next transmit antenna. Once all valid candidates for one transmit antenna are found, the best M partial vector-candidates are chosen to proceed with for the next transmit antenna. The best candidates are those with the smallest PEDs. Therefore, for every transmit antenna, the candidate-search process is followed by the sorting of found candidates, which also affects the overall latency of detection process. When the candidate-search for the last transmit antenna is performed, the best M final candidates are used to compute soft information for corresponding coded bits for the outer SISO decoder.

Reference may also be made to commonly owned US Patent Application Publication US 2005/0002359 A1, published Jan. 6, 2005, “Apparatus, and Associated Method, for Detecting Data Communicated to a Receiving Station in a Multiple-Channel Communication System”, Kyeong Jin Kim, which is incorporated herein in its entirety.

### SUMMARY OF THE EXEMPLARY EMBODIMENTS

The foregoing and other problems are overcome, and other advantages are realized, in accordance with the non-limiting and exemplary embodiments of this invention.

In a first aspect thereof the exemplary embodiments of this invention provide a method that includes receiving signals from y pairs of antennas, where y is greater than one, and where the received signals convey coded bits of information; processing signals received from pairs of the antennas in parallel to find partial Euclidian distances and determine valid partial candidates for individual antennas; sorting valid partial candidates to find M best partial candidates; combining the M best partial candidates into M² final candidates; and using the M² final candidates in parallel in a plurality of a posteriori probability function units, with corresponding final Euclidian distances, to determine a posteriori reliability information for coded bits.

In another aspect thereof the exemplary embodiments of this invention provide an apparatus that includes a receiver configurable to receive signals from y pairs of antennas, where y is greater than one, and where the received signals convey coded bits of information. The apparatus further includes a detection block comprised of a plurality of search modules configurable to process signals received from pairs of the antennas in parallel to find partial Euclidian distances and determine valid partial candidates for individual antennas; a plurality of sort modules configurable to sort the valid partial candidates to find M best partial candidates to be combined into M² final candidates; and further comprising a plurality of a posteriori probability function units arranged to process the M² final candidates in parallel, with corresponding final Euclidian distances, to determine a posteriori reliability information for coded bits.

In another aspect thereof the exemplary embodiments of this invention provide a computer-readable memory medium that stores program instructions, the execution of the program instructions resulting in operations that comprise simultaneously processing signals received from y pairs of antennas, where y is greater than one and where the received signals convey coded bits of information, to find partial Euclidian distances and determine valid partial candidates for individual antennas; sorting valid partial candidates to find M best partial candidates; combining the M best partial candidates into M² final candidates; and using the M² final candidates in parallel in a plurality of a posteriori probability function units, with corresponding final Euclidian distances, to determine a posteriori reliability information for coded bits.

In a further aspect thereof the exemplary embodiments of this invention provide an apparatus that includes means for simultaneously processing signals received from y pairs of antennas, where y is greater than one and where the received signals convey coded bits of information, for finding partial Euclidian distances and determining valid partial candidates for individual antennas; means for sorting valid partial candidates to find M best partial candidates; means for combining the M best partial candidates into M² final candidates; and means for using the M² final candidates in parallel in a plurality of a posteriori probability function units, with corresponding final Euclidian distances, for determining a posteriori reliability information for coded bits and outputting soft decoded bits to an outer channel decoder.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1A shows a matrix R that is helpful in describing the QRD-M algorithm.

FIG. 1B depicts the operation of the conventional QRD-M algorithm.

FIG. 2 shows the operation of the QRD-QLD detection algorithm in accordance with the exemplary embodiments of this invention.

FIG. 3 shows that during QRD-QLD detection the elements of R₂ in FIG. 2 are equivalent to the L matrix after QL decomposition of H¹ₛₒᵣₜ.

FIG. 4 illustrates a classical bounded search process.

FIG. 5 shows a search process (tree-search visualization) of the QRD-QLD detection algorithm.

FIG. 6 illustrates a table that contrasts the computational complexity of the QRD-M versus the QRD-QLD detection algorithm.

FIG. 7 illustrates a table that contrasts the computational complexity of the candidate search process of the QRD-M versus the QRD-QLD detection algorithm.

FIG. 8 shows an exemplary configuration of comparators that are applied to find the smallest element out of N elements in log₂ N comparator stages.

FIG. 9 illustrates a table that contrasts the estimated candidate search latency of the QRD-M versus the QRD-QLD detection algorithm.

FIG. 10 is useful for showing the difference in total latency between the QRD-M and the QRD-QLD detection algorithms with no outer feedback.

FIG. 11 is a graph that contrasts FER performance between the QRD-M and the QRD-QLD detection algorithms with no outer feedback.

FIG. 12 is a simplified block diagram of a receiver constructed to include a QRD-QLD detection algorithm block in accordance with the exemplary embodiments of this invention.

FIG. 13 is a block diagram of the soft sphere QRD-QLD detector in accordance with the exemplary embodiments of this invention.

FIG. 14 is a block diagram of arithmetic logic for computation of Rₘⱼ·cⱼ for a single value of j in the case of 16-QAM modulation, and shows in further detail a block diagram of a FU_{CSA} for computation of partial Rₘⱼ·cⱼ products.

FIG. 15 is a block diagram of a final stage of the search module for each transmit antenna: and depicts parallel square operations, computation of the P_{C}=2^{M}^{_{c}} PEDs by cross-addition and comparison with the pre-determined sphere radius.

FIG. 16 is a table showing numbers of utilized arithmetic function units for the antenna search module and the APP FUs shown in FIG. 13.

FIG. 17 shows in greater detail one of the sorting functional units, and illustrates that the sorting function unit is composed of a binary tree of comparators, where the search for a minimum is repeated M times if M smallest out of N numbers (partial Euclidian distances) are to be found.

### DESCRIPTION

The exemplary embodiments of this invention enable a further reduction in the detection complexity and latency of the sphere-type algorithm, while preserving (and even improving) the error-rate performance.

The use of the exemplary embodiments of this invention decreases processing latency of QRD-M detection while preserving the error-rate performance. The QRD-M algorithm with parameter M=16 is a detection scheme proposed for emerging MIMO OFDM downlink wireless receivers, such as the 3GPP-LTE, IMT-advance, 4G, WLAN, and WiMAX downlink receivers, and assumes a case of four transmit and receive antennas and 16-QAM modulation. This is but one non-limiting example of an application for the embodiments of this invention, as they may be readily applied in general to a number of systems having an equal number of antennas in the transmitter and the receiver.

The detection approach in accordance with the exemplary embodiments of this invention is compared below (in terms of detection latency, computational complexity and error-rate performance) with conventional QRD-M detection.

The exemplary embodiments of this invention provide an improved detection procedure, referred to for convenience as a QRD-QLD detection algorithm, that simplifies the candidate-search process as well as the sorting of found candidates. The use of QRD-QLD detection algorithm assumes pre-processing based on both QR decomposition and QL decomposition of the channel matrix. The QRD-QLD detection algorithm may be used, for example, as a detector in a downlink receiver (e.g., in a mobile subscriber equipment or more generally in a user equipment) in a wireless system with four transmit/receive antennas and 16-QAM modulation. More generally, the QRD-QLD detection algorithm may be used for any transmission between a base station and the mobile subscriber system that exhibits high spectral efficiency.

The implementation of the QRD-QLD detection algorithm may be particularly advantageous in an integrated circuit embodiment, such as embodied in an ASIC, as it provides benefits in terms of area requirements, cost and detection latency. One important benefit of the use of QRD-QLD detection algorithm is that it may include identical arithmetic function units, such as the search function unit and sorting module, as for the QRD-M approach. As a result, a common ASIC design may need only a modest hardware overhead to implement both the conventional QRD-M detection algorithm and the QRD-QLD detection algorithm in accordance with the exemplary embodiments of this invention.

As such, it should be noted that a reference herein to the “QRD-QLD detection algorithm” or to the “QRD-QLD algorithm” is not intended to limit the embodiments of the invention to computer program code or computer program instructions stored in a computer-readable memory medium. That is, the QRD-QLD algorithm may be implemented entirely in hardware (for example, within an integrated circuit), or it may be implemented as a combination of hardware and computer program instructions, or it may be implemented entirely in software (e.g., entirely as computer program instructions executed by, for example, a digital signal processor).

One significant advantage that is gained by the use of QRD-QLD detection algorithm is a simplified candidate-search process. For example, if a wireless system with four transmit/receive antennas is assumed, the candidate-search process is divided into two parallel and independent search processes for two pairs of transmit antennas. The number of search operations is substantially reduced as compared to the QRD-M approach.

A search operation is considered herein as the testing of all constellation points to determine whether the constellation points are within a pre-determined spherical region. The updating of PEDs is based on the PED of a previously found parent candidate. After finding partial candidates for two pairs of transmit antennas, the best M partial candidates for each group are determined and combined together to provide a list of M² final candidates. It may be observed that the complexity of candidate-sorting (i.e., the sorting of computed PEDs) is reduced as compared to the conventional QRD-M approach (with M=16), where candidate-sorting is employed for each transmit antenna. Furthermore, the QL decomposition, as a pre-processing portion of the QRD-QLD algorithm, can be avoided and replaced with QR decomposition of the channel matrix with the columns in reverse order. As a result, an additional hardware unit for QL decomposition is not required.

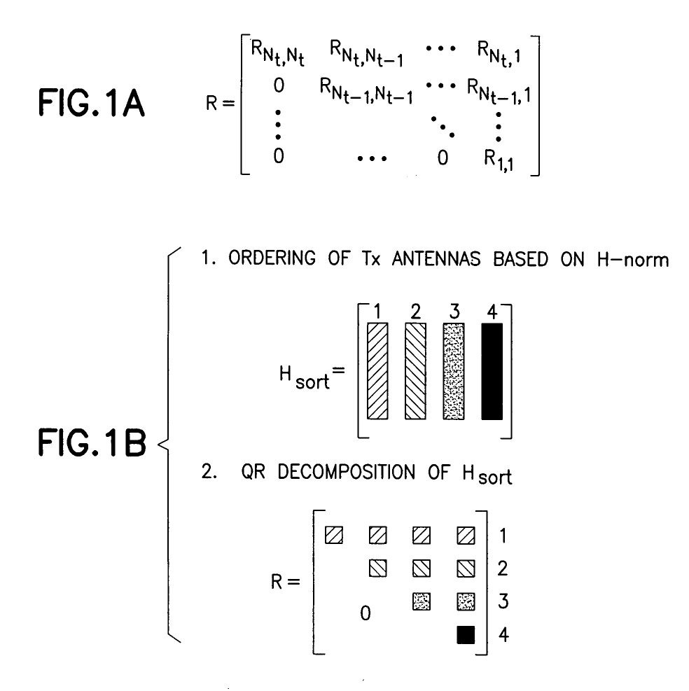

Describing now in further detail the QRD-QLD algorithm in accordance with the exemplary embodiments of this invention, reference is made first to FIG. 1B which depicts the operation of the conventional QRD-M algorithm, where the ordering of the Tx antennas is based on column-norms of the channel matrix, and the QR decomposition of sorted channel matrix Hₛₒᵣₜ. In this example Tx antenna 4 is the most reliable (it exhibits the largest column-norm), and the search order is 4→3→2→1. The M best candidates are retained after every search level.

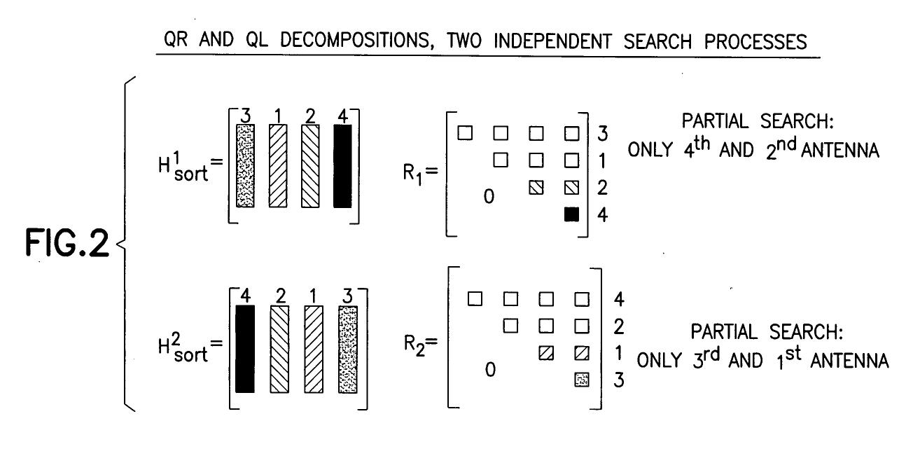

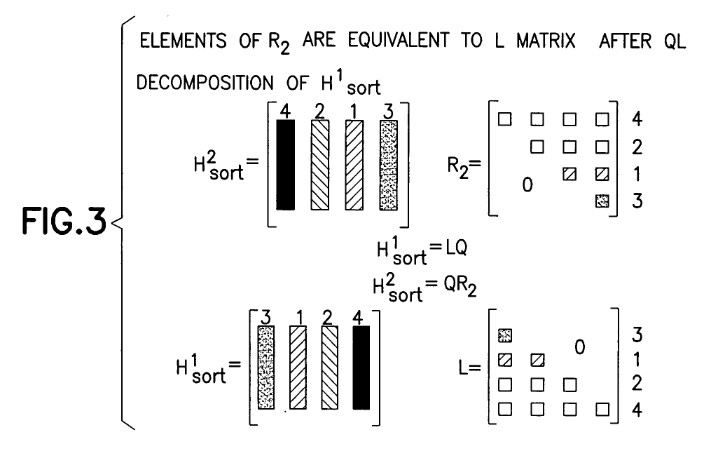

FIG. 2 shows the operation of the QRD-QLD detection algorithm in accordance with the exemplary embodiments of this invention. In this non-limiting four antenna example there are performed QR and QL decompositions, with two independent search processes. In the first partial search H¹ₛₒᵣₜ only the 4th and 2nd antennas are considered, while in the second partial search H²ₛₒᵣₜ only the 3rd and 1st antennas are considered.

FIG. 3 shows that during QRD-QLD detection the elements of R₂ in FIG. 2 are equivalent to the L matrix after QL decomposition of H¹ₛₒᵣₜ.

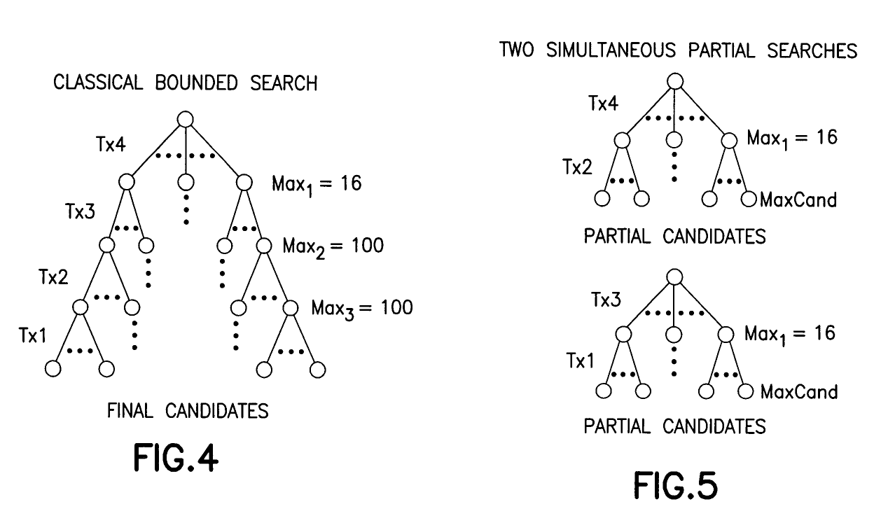

FIG. 4 illustrates a classical bounded search, in this case a breath-first bounded candidate-search process, and represents a tree-search visualization with a variable search bound. The number of search levels corresponds to the number of Tx antennas (assumed to be four in this example). The result of the search is that a set of final transmitted symbol-candidates are determined.

In contrast to FIG. 4, FIG. 5 shows the search process (tree-search visualization) of the QRD-QLD detection algorithm in accordance with the exemplary embodiments of this invention. Two parallel and independent search processes (possibly conducted simultaneously and in parallel) for two groups of Tx antennas are employed (again, 4 Tx antennas are assumed). In this case a set of partial candidates (not final candidates) for each search group is determined.

It can thus be observed by comparing FIGS. 4 and 5 that two parallel and inherently less complex search processes are needed when using the QRD-QLD detection algorithm, and that the number of search operations is reduced from (1+Max₁+Max₂+Max₃) to 2×(1+Max₁). Further, only partial candidates for two pairs of Tx antennas are obtained (up to MaxCand partial candidates for each Tx pair). Further, the best M out of the MaxCand partial candidates are selected, and combining then provides the M² final candidates.

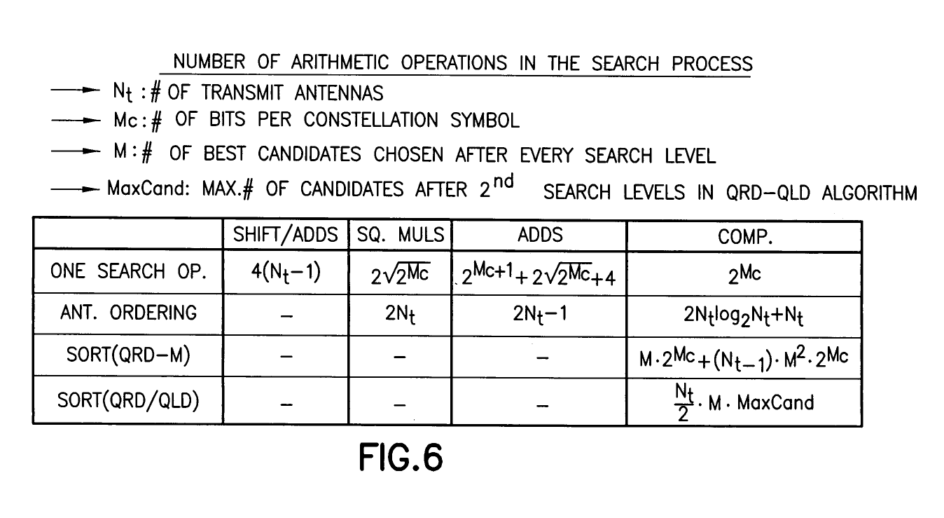

FIG. 6 illustrates a table that contrasts the computational complexity of the QRD-M versus the QRD-QLD detection algorithm, and which shows the significant reduction in computational complexity that is achieved.

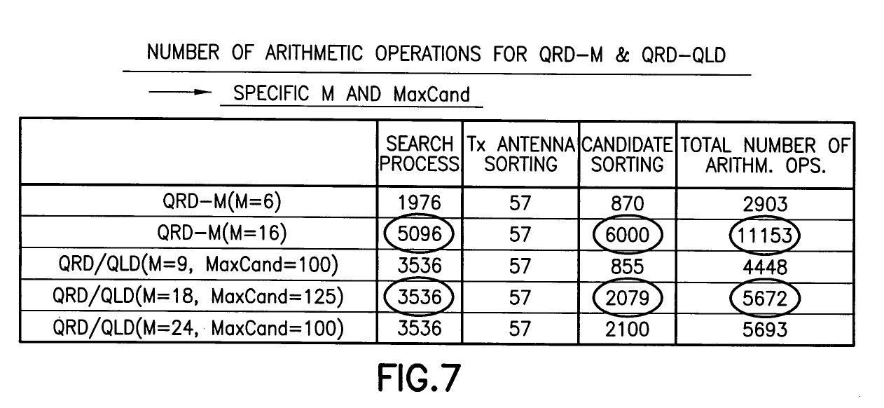

FIG. 7 illustrates a table that contrasts the computational complexity of the candidate search process of the QRD-M versus the QRD-QLD detection algorithm. The table assumes values of M=6 and M=16 for the QRD-M case, and M=9, M=18 and M=24 for the QRD-QLD case, and also illustrates the significant reduction in computational complexity (total number of arithmetic operations required for the search process and the sorting of candidates) that is achieved by the use of the QRD-QLD detection algorithm.

Regarding the latency of the detection process, the latency of the search operations plus candidate sorting, for the QRD-M approach, is given by:

$$\begin{matrix}\begin{matrix}Latency\_QRDM \approx [ 1 + ( {N}_{t} - 1 ) \cdot M ] \times Latency\_search \_op . + \\ M \cdot [ α + {M}_{C} ] \times Lantency\_compare \_op . + M \cdot \end{matrix} \\ [ ( {N}_{t} - 1 ) \cdot ( β + ⌈ {log}_{2} ( M \cdot {2}^{{M}_{C}} ) ⌉ ) ] \times Latency\_compare \_op .\end{matrix}$$

This can be contrasted with the latency observed for the QRD-QLD detection algorithm, which is given by:

$$\begin{matrix}Latency\_QRD \_QLD \approx ( 1 + {2}^{{M}_{C}} ) \times Latency\_search \_op . + M \cdot \\ ( γ + ⌈ {log}_{2} MaxCard ⌉ ) \times Latency\_compare \_op .\end{matrix}$$

The parameters α, β and γγ depend on the number of comparators used. In general, these parameters are equal to zero if there are a sufficient number of comparators for the maximum level of processing parallelism, otherwise they account for the additional comparison delay, in clock cycles, per search level.

For the QRD-M approach, at the first level the algorithm finds the M best out of 2^{Mc} candidates, and from the 2nd to the 4th levels finds the M best out of M*2^{Mc} candidates. In contrast, the QRD-QLD algorithm finds the M best out of MaxCand candidates after the 2nd search level. With the available number of comparators, the algorithm finds the smallest PED, and excludes it from the sorting list, then finds the next smallest PED, excludes it from the sorting list, and so forth.

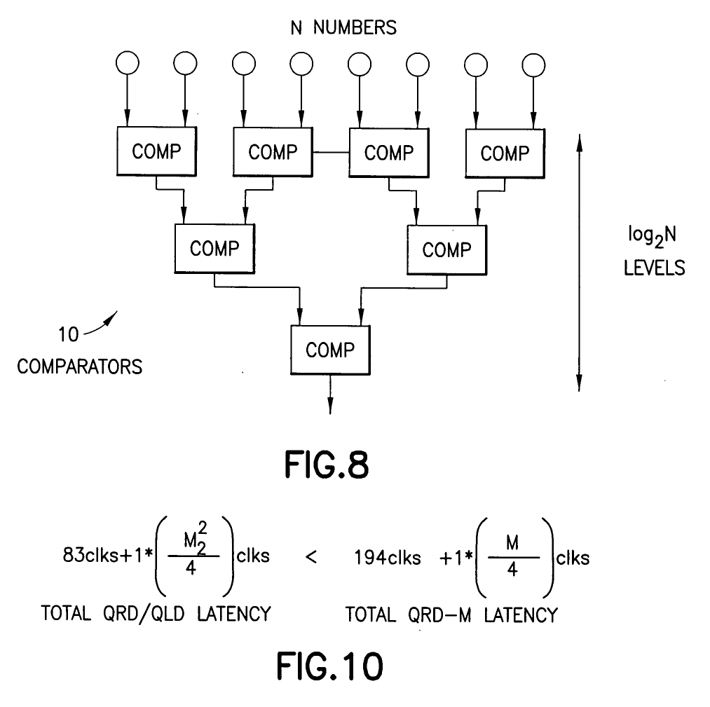

For a classical sorting of N numbers, such as in a bubble sort, the average complexity is given by N*log₂ N. However, for the search of M smallest values (PED values) the complexity is reduced to M*(ξ+log₂ N), M<<N where ξ is the additional latency if the available number of comparators cannot support full parallelism. FIG. 8 shows an exemplary configuration of comparators 10 that are applied to find the smallest element out of N elements in log₂ N comparator stages.

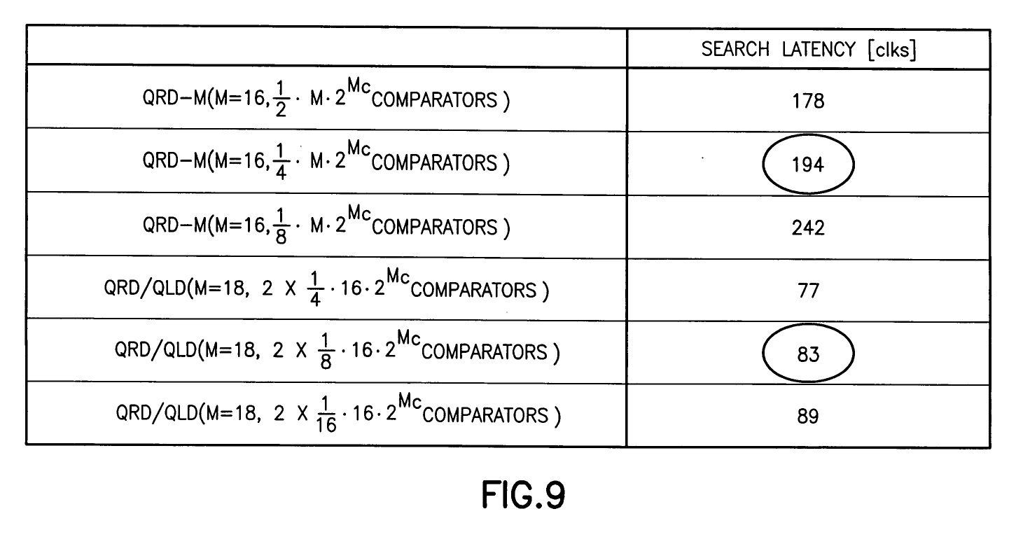

FIG. 9 illustrates a table that contrasts the estimated candidate search latency of the QRD-M versus the QRD-QLD detection algorithm. This example assumes a non-limiting clock frequency of 200 MHz, where the latency of the search operation is about two clock cycles, and the latency of the compare operation is about 0.3 clock cycles. The example also assumes two search units each having the same number of comparators.

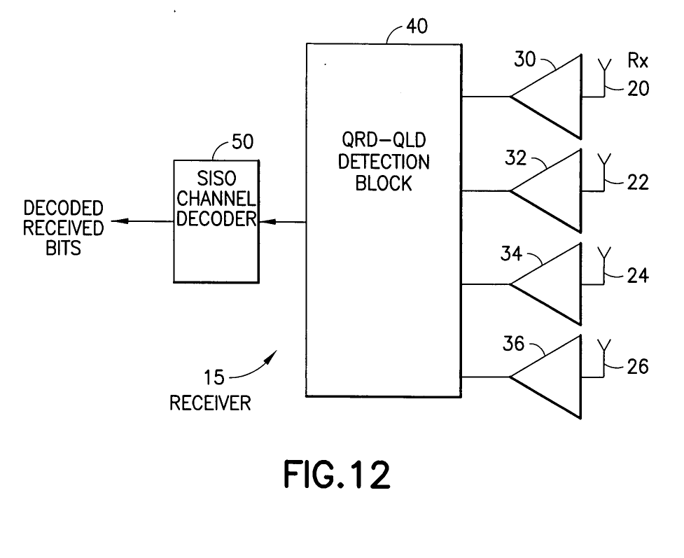

Reference is made to FIG. 12 for showing a receiver 15 that is constructed and operated in accordance with the exemplary embodiments of this invention. A plurality of radio frequency receive antennas (e.g., 4) 20, 22, 24 and 26 are connected with corresponding radio receiver circuits 30, 32, 34, 36, respectively. The receiver circuits 30, 32, 34, 36 have outputs coupled to baseband (BB) circuitry that includes a QRD-QLD detection block 40 that incorporates at least a pair of comparator circuits 10 as shown in FIG. 8 for sorting, as well as at least two searchers and other circuitry. An output of the QRD-QLD detection block 40 is connected with an outer decoder, such as a SISO channel decoder 50, and provides soft outputs thereto. The SISO channel decoder 50 outputs decoded received bits to further BB circuitry (not shown).

The latency of updating the soft information to the SISO channel decoder 50 for a final candidate soft decision can be about one clock cycle (e.g. for a 200 MHz clock frequency). The overall latency for the QRD-QRL detection block 40, assuming M=18, and M² final candidates, is about 81 clock cycles.

Assuming a case of no feedback from the SISO channel decoder 50 to the QRD-QLD detection block 40 (to avoid increased latency and increased power dissipation), four parallel a posteriori probability functional units (APP FUS), 64 comparators for sorting, and two search units, the reduction in total latency, versus the conventional QRD-M approach, is illustrated in FIG. 10. By example, for the case of QRD-M with M=16, as proposed for 3GPP-LTE, with 4×4 QAM, M₂<21.44.

It can be noted that the parameter M in the QRD-QLD detection block 40 can be variable, and may be a function of channel conditions. In general, a larger sum of the diagonal elements in the upper triangular matrix R implies a better channel condition, and vice versa (a smaller value of M is sufficient for good channels, and vice versa).

It can be shown that, using the same hardware resources, the total detection latency with conventional QRD-M with M=16 is about 198 clock cycles, while the total detection latency with QRD-QLD with average M equal to 17.75 is about 162 clock cycles, which is a significant improvement.

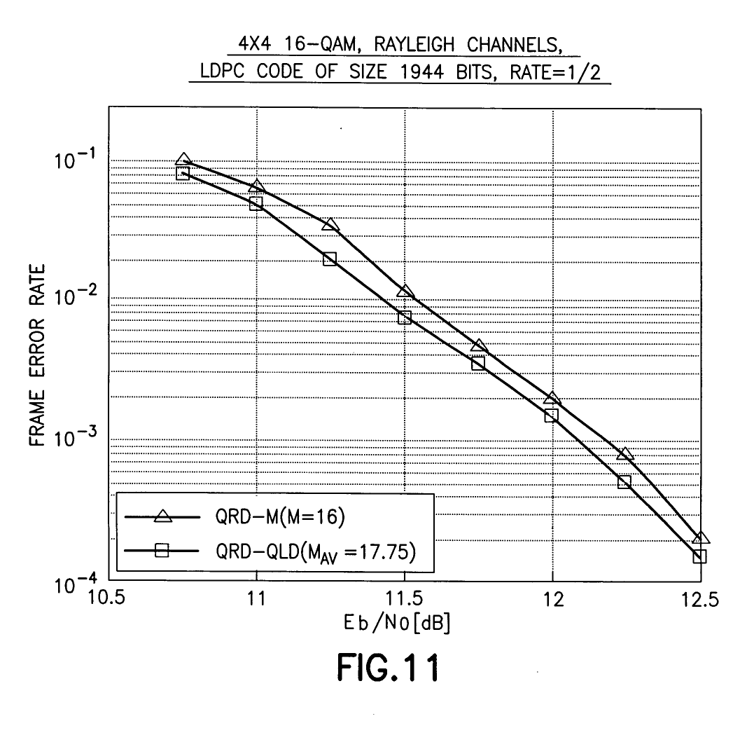

FIG. 11 illustrates a frame error-rate performance of QRD-M detection with parameter M=16, and QRD-QLD with variable parameter M. The average M is equal to 17.75 and depends on the channel condition. A smaller value of M is sufficient in good channels, while a large M is needed in bad channels. This example assumes a wireless system with four transmit and four receive antennas with 16-QAM modulation, where an outer LDPC decoder is used, the codeword size is 1944 bits, rate is ½, and there are up to 15 inner iterations of layered belief propagation algorithm.

As should be appreciated, a QRD-QLD soft sphere detection apparatus and method has been herewith described. The QRD-QLD detector 40 is suitable to be implemented (at least partially) in an integrated circuit, such as in a customized ASIC.

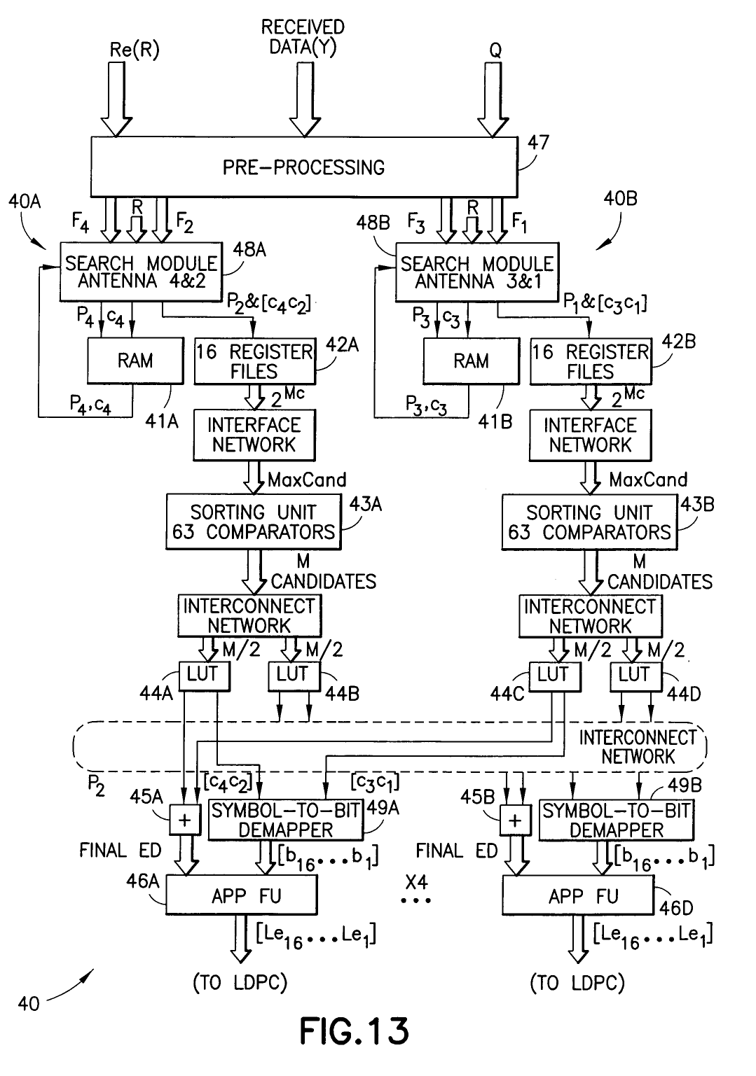

Describing now the exemplary embodiments in even greater detail, reference can be made to FIG. 13 for showing block diagram of the soft sphere QRD-QLD detector 40. It is assumed for convenience, and not as a limitation, that there are four transmit/receive antennas in the system with 16-QAM modulation. There are two parallel arithmetic blocks 40A, 40B for computation of partial Euclidian distances (EDs) as well as for the search of candidates for two pairs (groups) of transmit antennas. Valid candidates for one transmit antenna (one search level) and their corresponding partial EDs are stored in a RAM blocks 41A, 41B and used in the subsequent search level. Both groups of partial candidates are first stored in register files 42A, 42B and then sorted in sort units 43A, 43B to find M best partial candidates (those candidates with the smallest partial EDs).

Best partial candidates are stored in Look-up Tables (LUTs) 44A, 44B, 44C, 44D and combined together by blocks 45A, 45B into M² final candidates. The final candidates are utilized by four parallel a posteriori probability (APP) function units (APP FUs) 46A-46D via symbol-to-bit demappers 49A, 49B, with corresponding final EDs. The APP FU 46 computes the a posteriori reliability information for coded bits based on the list of final candidates.

Interface networks and interconnect networks are also depicted in FIG. 13 disposed between the search modules 48 and the sorting units 43, and between the sorting units 43 and the APP FUs 46, respectively.

FIG. 13 shows that the arithmetic logic is composed of several sub-components: a pre-processing unit 47, candidate-search modules 48A, 48B, the sorting units 43A, 43B, and the APP function units 46A-46B. Sorting of transmit antennas and QR decomposition of sub-carrier channel matrices are assumed to be performed before the pre-processing stage 47 using any suitable conventional techniques.

Pre-Processing Unit 47

The pre-processing unit 47 calculates center of the hyper-sphere, as well as the common factors defined below in Eq. 2 used for testing all symbol-candidates for each transmit antenna. The center of the hyper-sphere is calculated as:

ŷ=Q^{H}·y. (1)

Factors Fₘ are pre-computed in advance for all symbol-candidates according to:

Fₘ=ŷₘ−Rₘₘ·sₘₘ, m=Nₜ, . . . , 1. (2)

These factors are computed for all Nₜ transmit antennas, saved in the registers 42A, 42B, and utilized in the appropriate search level. It is not required to compute all 2·2^{M}^{_{c}} products Rₘₘ·sₘ per search level as there are only eight different products in the case of 16-QAM (four real and four imaginary parts), which correspond to the number of constellation levels. Furthermore, rather than to compute products, it is possible to apply shift/add operations on Rₘₘ values due to the known levels of constellation points.

Search Modules 48A, 48B

The search modules 48A, 48B simultaneously compute partial Euclidian distances (PEDs) for all P_{C}=2^{M}^{_{c}} constellation points. All PEDs that are computed in a single search operation correspond to a common partial candidate found in the previous search level. Once computed, all PEDs are simultaneously tested to determine if they are inside the sphere. Then, up to P_{C} valid candidates along with their PEDs are saved in the RAM memory 41A, 41B for later use.

As was noted, if one assumes a wireless system with Nₜ=4 transmit antennas the order in which transmit antennas are detected is irrelevant for the architecture design. In this particular case the order is: search for antenna 4 followed by antenna 2 in search module 48A, performed in parallel with the search for antenna 3 followed by antenna 1 in search module 48B. The search module 48 for the first detected transmit antenna (4^{th} transmit antenna or the most reliable antenna determined after reordering of channel columns) computes PEDs for all 2^{M}^{_{c}} constellation points and checks if they are inside the pre-determined hyper-sphere according to:

P₄^{q}=|F₄^{q}|²≦r²; q=1, . . . 2^{M}^{_{c}}. (3)

For every valid candidate c₄ from the first search level, cumulative PEDs of the fourth and second transmit antennas are computed in the second search level within the same search module 48 according to:

P₂^{q}=P₄(c₂)+|F₃^{q}−R₄₃c₄|²≦r²; q=1, . . . 2^{M}^{_{c}}. (4)

The second search module 48B computes in parallel the same equations for the third and first transmit antenna:

P₃^{q}=|F₁^{q}|²≦r²; q=1, . . . 2^{M}^{_{c}}. (5)

For every valid candidate c₃ from the third transmit antenna (the second most reliable antenna), cumulative PEDs of the third and first transmit antennas are computed as:

P₁^{q}=P₃(c₂)+|F₂^{q}−R₁₂c₃|²≦r²; q=1, . . . 2^{M}^{_{c}}. (6)

If the maximum pre-determined number of candidates for two initial search levels is found, the search process stops. Partial vector-candidates are combined into M² final vector-candidates [c₄c₂c₃c₁] after determining the best M candidates for two pairs of transmit antennas. The best partial candidates are saved in the LUTs 44A-44D and used in the computation of APP messages for the outer decoder 50.

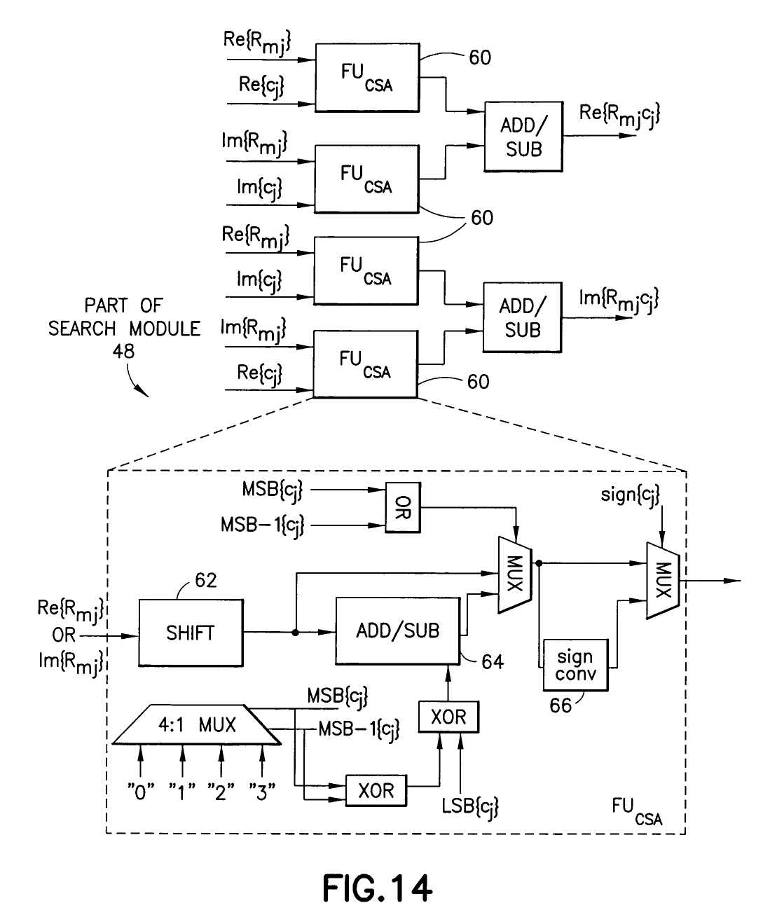

For fully parallel computation of all products Rₘⱼ·cⱼ inside every search level j (j=m, . . . , Nₜ), up to twelve FU_{CSA} function units 60 (check/shift/add function unit, see FIG. 14) and up to six add/subtract units are used. Assuming the use of four transmit antennas with 16-QAM, the FU_{CSA} 60 checks the constellation level of symbol-candidate cⱼ for the j-th transmit antenna and then performs appropriate shift, add/subtract operations (logic units 62, 64) and sign-conversion (logic unit 66) on real and imaginary parts of the Rₘⱼ entry of upper triangular matrix R. Arithmetic logic used for computation of a single factor Rₘⱼ·cⱼ is shown in FIG. 14. A given FU_{CSA} 60 also includes various support logic functions, including OR and XOR logical elements and multiplexers.

It can be observed that computation of Euclidian distances from Eq. 4 can be rewritten as:

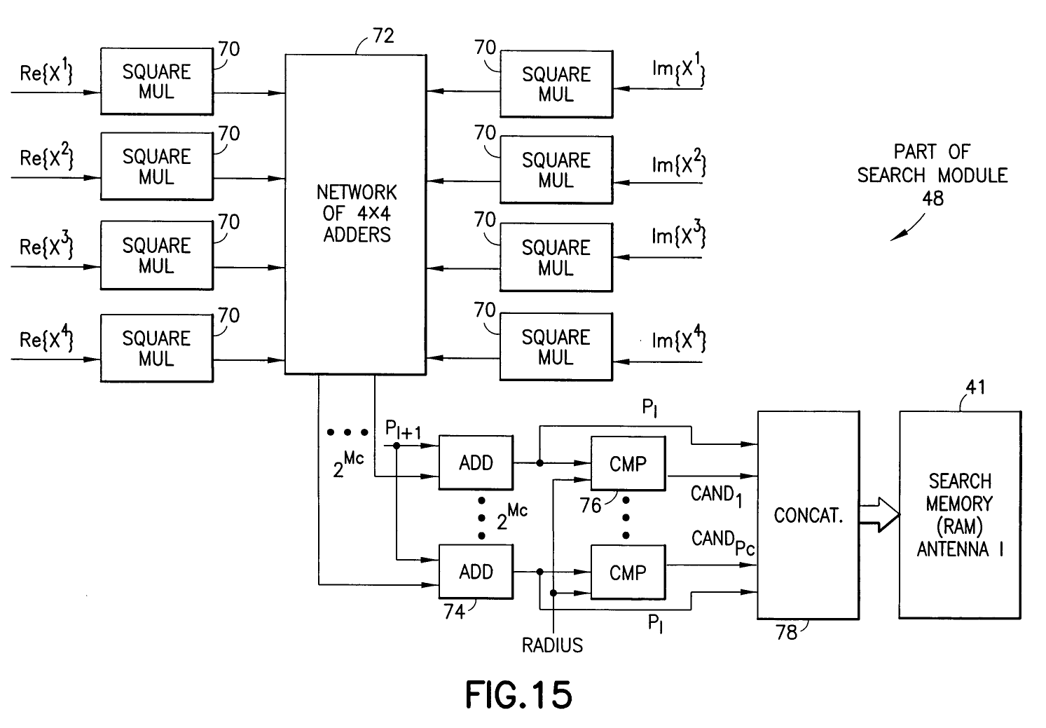

P₂=P₄(c₄)+|Re{X}+iIm{X}|²≦r², (7)

where X=F₃−R₄₃c₄ . There are four different values of Re{X} and four different values of Im{X} in the case of 16-QAM. Therefore, and referring also to FIG. 15, fully parallel computation of |X|² uses eight square multipliers 70, and P_{C}=2^{M}^{_{c}}=16 different values of |X|² are formed by the cross-addition in a network of 4×4 adders 72 of all individual results of square multiplications. FIG. 15 also shows 2^{M}^{_{c}} adders 74 and comparators 76, followed by a concatenation block 78 that provides an output to the search memory RAM 41. Reference can also be made to FIG. 17.

APP Function Units 46A-46D

The APP FUs 46A-46D simultaneously compute the a posteriori probabilities for M·M_{C} coded bits transmitted per one channel realization. A de-mapping of the final vector of symbol-candidates s into bits xₖ (k=1, . . . , M·M_{C}) is employed. It can be noticed that an already-computed Euclidian distance ED(s) that corresponds to the final vector-candidate s can be directly used for computation of extrinsic probabilities:

$${L}_{E} ( {x}_{k} \vert y ) \approx \frac{1}{2} {max}_{x ∈ L ⋂ {X}_{k , + 1}} \{ - \frac{1}{{σ}^{2}} ED ( s ) + {x}_{[ k ]}^{T} \cdot {L}_{{A}_{,} [ k ]} \} - \frac{1}{2} {max}_{x ∈ L ⋂ {X}_{k , - 1}} \{ - \frac{1}{{σ}^{2}} ED ( s ) + {x}_{[ k ]}^{T} \cdot {L}_{{A}_{,} [ k ]} \} \qquad ( 8 )$$

In order to simplify the computation, the inner product between the a priori probabilities and coded bits is calculated using the sign-conversion and summation, and then the appropriate L_{A}(xₖ) is excluded:

x_{[k]}^{T}·L_{A,[k]}=x^{T}·L_{A}−sign(xₖ)·L_{A}(xₖ), ∀k=1, . . . , M·M_{C}. (9)

M·M_{C} updated extrinsic probabilities L_{E}(xₖ|y) are directly stored into memory of the outer LDPC decoder 50.

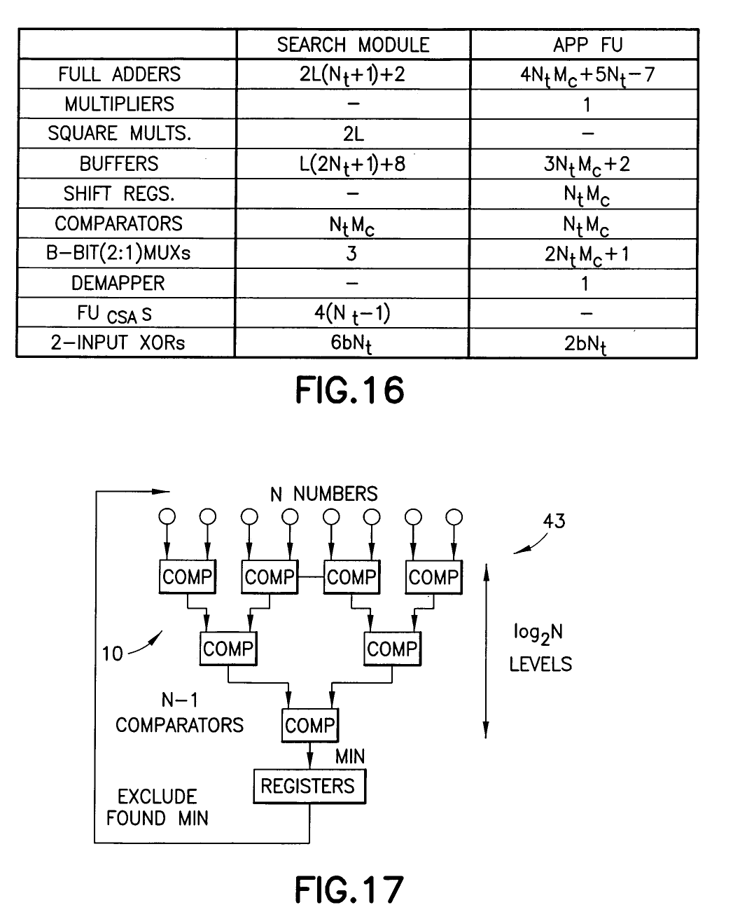

The Table in FIG. 16 shows exemplary and non-limiting numbers of arithmetic function units utilized for one antenna search module 48 and APP FU46, where Nₜ represents the number of transmit antennas, the parameter L is the number of constellation levels (four levels for 16-QAM), M_{C} is the number of information bits represented with a QAM constellation symbol, and b is the bit-size of fixed-point arithmetic precision. The check-shift-add FU_{CSA} function unit was described above and shown in FIG. 14.

Sorting Units 43A, 43B

The sorting function units 43A, 43B each include a binary tree of comparators 10 as shown in FIG. 17 (and FIG. 8). In the exemplary embodiment there are 63 comparators connected in six stages, and there are up to 100 partial EDs that are sorted in order to locate M smallest PEDs (M best partial candidates). Once the global minimum is found, a particular partial ED is excluded and the search for the minimum is repeated in order to find the second smallest partial ED. This process is repeated M times, and M best partial candidates are available. Those partial candidates are stored into the LUTs 44A-44D and combined together by units 45A, 45B with partial candidates for the other pair of transmit antennas. Four final candidates are simultaneously combined as shown in FIG. 13 and utilized by the four parallel APP FUs 46A-46D. Four groups of 2^{Mc}=16 APP messages are available to be stored in the memory of the outer decoder 50 (e.g., LDPC or Turbo decoder).

In summary, as compared with conventional QRD-M proposed for 3GPP-LTE, IMT-advance, WLAN, WiMAX and an advanced 4G downlink, the QRD-QLD detection algorithm can provide about a two times improvement in the candidate search process for a same or similar error rate performance. Furthermore, only one iteration is needed between the detector 40 and the decoder 50. Furthermore, there is a smaller overall latency with the QRD-QLD approach, with an error rate performance gain over conventional QRD-M.

As was described above, in general the candidate-search process in accordance with these exemplary embodiments is divided into two independent sub-parts for two groups of transmit antennas (assuming an even number of transmit antennas). Within each group the search process is performed sequentially from one transmit antenna to another, providing the breadth-first searching for candidates within the sphere around the received point.

As was noted, the exemplary embodiments of this invention may be used as a detection means in downlink MIMO OFDM receivers for 3GPP-LTE, IMT-advance, 4G, WLAN, and WiMAX standards. It may be used in, for example, a wireless system with four transmit/receive antennas and 16-QAM modulation, which is one possible option in the 3GPP-LTE, IMT-advance, IEEE 802.11n, and IEEE 802.16 standards. The exemplary embodiments of this invention clearly provide superior performance to the conventional QRD-M algorithm with parameter M equal to 16, and provides enhancements in terms of maximum detection latency and error-rate performance.

As was also noted above, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations may become apparent to those skilled in the relevant arts in view of the foregoing description, when read in conjunction with the accompanying drawings and the appended claims. As but some examples, the use of other similar or equivalent logical circuits and the like may be attempted by those skilled in the art. However, all such and similar modifications of the teachings of this invention will still fall within the scope of this invention.

Further, while the exemplary embodiments have been described above in the context of the E-UTRAN (UTRAN-LTE) and other wireless systems, it should be appreciated that the exemplary embodiments of this invention are not limited for use with only these particular types of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method comprising:
receiving signals from y pairs of antennas, where y is greater than one, and where the received signals convey coded bits of information;
processing signals received from pairs of the antennas in parallel to find partial Euclidian distances and determine valid partial candidates for individual antennas;
sorting valid partial candidates to find M best partial candidates;
combining the M best partial candidates into M² final candidates; and
using the M² final candidates in parallel in a plurality of a posteriori probability function units, with corresponding final Euclidian distances, to determine a posteriori reliability information for coded bits.

2. The method of claim 1, further comprising outputting soft decoded bits to an outer channel decoder.

3. The method of claim 1, where y is equal to 2, and where received signals are received from four antennas 1, 2, 3 and 4 and are modulated using 16-QAM modulation.

4. The method of 3, where processing processes received signals from antennas 1 and 3 in a first search module in parallel with received signals from antennas 2 and 4 in a second search module, where in the first search module the search is conducted first for antenna 3 followed by antenna 1, and where in the second search module the search is conducted first for antenna 4 followed by antenna 2.

5. The method of claim 4, where sorting sorts the valid partial candidates output from the first search module in a first sorting module in parallel with the valid partial candidates output from the second search module in a second sorting module, and further comprising outputting from each sorting module the M best partial candidates to the a posteriori probability function units, where each sorting module comprises a binary tree of comparators having log₂ N levels, where N is the number of candidates to be sorted.

6. The method of claim 1, where processing signals comprises an initial step of pre-processing the received signals to calculate a center of a hyper-sphere and common factors used for testing symbol candidates for each antenna.

7. The method of claim 6, where all partial Euclidian distances are simultaneously tested to determine if they are inside the hyper-sphere to determine valid candidate constellation points, further comprising saving valid constellation candidates in conjunction with associated partial Euclidian distances.

8. The method of claim 1, where sorting comprises sorting the partial Euclidian distances to locate M smallest partial Euclidian distances representing M best partial candidates; determining a global minimum and excluding a particular corresponding partial Euclidian distance; and repeating M times to generate the M best partial candidates for combining into the M² final candidates.

9. The method of claim 1, executed to implement a QRD-QLD detection algorithm.

10. The method of claim 1, executed in a wireless MIMO OFDM downlink receiver.

11. An apparatus comprising:
a receiver configurable to receive signals from y pairs of antennas, where y is greater than one, and where the received signals convey coded bits of information; and
a detection block comprised of a plurality of search modules configurable to process signals received from pairs of the antennas in parallel to find partial Euclidian distances and determine valid partial candidates for individual antennas; a plurality of sort modules configurable to sort the valid partial candidates to find M best partial candidates to be combined into M² final candidates; and further comprising a plurality of a posteriori probability function units arranged to process the M² final candidates in parallel, with corresponding final Euclidian distances, to determine a posteriori reliability information for coded bits.

12. The apparatus of claim 11, where outputs of the a posteriori probability function units output soft decoded bits to an outer channel decoder unit.

13. The apparatus of claim 11, where y is equal to 2, and where received signals are received from four antennas 1, 2, 3 and 4 and are modulated using 16-QAM modulation.

14. The apparatus of claim 13, where said search modules are configured to operate on received signals from antennas 1 and 3 in a first search module in parallel with received signals from antennas 2 and 4 in a second search module, where in the first search module the search is conducted first for antenna 3 followed by antenna 1, and where in the second search module the search is conducted first for antenna 4 followed by antenna 2.

15. The apparatus of claim 14, where said sort modules are configured to sort the valid partial candidates output from the first search module in a first sorting module in parallel with the valid partial candidates output from the second search module in a second sorting module, and to output from each sorting module the M best partial candidates to the a posteriori probability function units, where each sort module comprises a binary tree of comparators having log₂ N levels, where N is the total number of antennas.

16. The apparatus of claim 11, further comprising a pre-processing unit configurable to input the received signals to calculate a center of a hyper-sphere and common factors used for testing symbol candidates for each antenna.

17. The apparatus of claim 16, where all partial Euclidian distances are simultaneously tested to determine if they are inside the hyper-sphere to determine valid candidate constellation points, further comprising a memory configurable to save valid constellation candidates in conjunction with associated partial Euclidian distances.

18. The apparatus of claim 11, where said sort modules are configurable to sort the partial Euclidian distances to locate M smallest partial Euclidian distances representing M best partial candidates; to determine a global minimum and to exclude a particular corresponding partial Euclidian distance; and to repeat M times to generate the M best partial candidates for combining into the M² final candidates.

19. The apparatus of claim 11, embodied at least partially as an integrated circuit.

20. The apparatus of claim 11, embodied as a QRD-QLD detection algorithm as part of a wireless MIMO OFDM downlink receiver.

21. A computer-readable memory medium that stores program instructions the execution of which result in operations that comprise:
simultaneously processing signals received from y pairs of antennas, where y is greater than one and where the received signals convey coded bits of information, to find partial Euclidian distances and determine valid partial candidates for individual antennas;
sorting valid partial candidates to find M best partial candidates;
combining the M best partial candidates into M² final candidates; and
using the M² final candidates in parallel in a plurality of a posteriori probability function units, with corresponding final Euclidian distances, to determine a posteriori reliability information for coded bits.

22. The computer-readable memory medium of claim 21, further comprising an operation of outputting soft decoded bits to an outer channel decoder.

23. The computer-readable memory medium of claim 22, where y is equal to 2, where received signals are received from four antennas 1, 2, 3 and 4 and are modulated using 16-QAM modulation, where processing processes received signals from antennas 1 and 3 in a first search module in parallel with received signals from antennas 2 and 4 in a second search module, where in the first search module the search is conducted first for antenna 3 followed by antenna 1, and where in the second search module the search is conducted first for antenna 4 followed by antenna 2, and where the sorting operation sorts the valid partial candidates output from the first search module in a first sorting module in parallel with the valid partial candidates output from the second search module in a second sorting module, and further comprises outputting from each sorting module the M best partial candidates to the a posteriori probability function units, where each sorting module comprises a binary tree of comparators having log₂ N levels, where N is the number of candidates to be sorted.

24. The computer-readable memory medium of claim 21, comprising an initial operation of pre-processing the received signals to calculate a center of a hyper-sphere and common factors used for testing symbol candidates for each antenna, where all partial Euclidian distances are simultaneously tested to determine if they are inside the hyper-sphere to determine valid candidate constellation points, and further comprising saving valid constellation candidates in conjunction with associated partial Euclidian distances.

25. The computer-readable memory medium of claim 21, where sorting comprises sorting the partial Euclidian distances to locate M smallest partial Euclidian distances representing M best partial candidates; determining a global minimum and excluding a particular corresponding partial Euclidian distance; and repeating M times to generate the M best partial candidates for combining into the M² final candidates.

26. The computer-readable memory medium of claim 21, providing a QRD-QLD detection algorithm as part of a wireless MIMO OFDM downlink receiver.

27. An apparatus, comprising:
means for simultaneously processing signals received from y pairs of antennas, where y is greater than one and where the received signals convey coded bits of information, for finding partial Euclidian distances and determining valid partial candidates for individual antennas;
means for sorting valid partial candidates to find M best partial candidates;
means for combining the M best partial candidates into M² final candidates; and
means for using the M² final candidates in parallel in a plurality of a posteriori probability function units, with corresponding final Euclidian distances, for determining a posteriori reliability information for coded bits and outputting soft decoded bits to an outer channel decoder.

28. The apparatus of claim 27, where y is equal to 2, where received signals are received from four antennas 1, 2, 3 and 4 and are modulated using 16-QAM modulation, where said processing means processes received signals from antennas 1 and 3 in a first search module in parallel with received signals from antennas 2 and 4 in a second search module, where in the first search module the search is conducted first for antenna 3 followed by antenna 1, and where in the second search module the search is conducted first for antenna 4 followed by antenna 2, and where said sorting means sorts the valid partial candidates output from the first search module in a first sorting module in parallel with the valid partial candidates output from the second search module in a second sorting module and outputting from each sorting module the M best partial candidates to the a posteriori probability function units, where each sorting module comprises a binary tree of comparators having log₂ N levels, where N is the number of candidates to be sorted.

29. The apparatus of claim 27, further comprising means for pre-processing the received signals for calculating a center of a hyper-sphere and common factors used for testing symbol candidates for each antenna, where all partial Euclidian distances are simultaneously tested to determine if they are inside the hyper-sphere to determine valid candidate constellation points, and further comprising means for saving valid constellation candidates in conjunction with associated partial Euclidian distances.

30. The apparatus of claim 27, where said sorting means comprises means for recursively sorting the partial Euclidian distances to locate M smallest partial Euclidian distances representing M best partial candidates; means for determining a global minimum and means for excluding a particular corresponding partial Euclidian distance; where recursively sorting operates M times to generate the M best, partial candidates for combining into the M² final candidates.

31. The apparatus of claim 27, embodied at least partially as an integrated circuit providing a QRD-QLD detection algorithm as part of a wireless MIMO OFDM downlink receiver.
